(19) United States
(12) Patent Application Publication
(10) Pub. No.: US 2004/0138089 A1
(43) Pub. Date: Jul. 15, 2004

(54) Quaternized protein hydrolyzates and methods of treating fabrics with compositions containing the same

(76) Inventors: Rolf Wachter, Duesseldorf (DE); Rita Koester, Duesseldorf (DE); Ditmar Kischkel, Monheim (DE)

Correspondence Address: COGNIS CORPORATION, PATENT DEPARTMENT, 300 BROOKSIDE AVENUE, AMBLER, PA, 19002, US

(21) Appl. No.: 10/702,668

(22) Filed: Nov. 6, 2003

(30) Foreign Application Priority Data
Nov. 15, 2002 (DE) 102 53 217.6

(51) Int. Cl. C11D 1/00

(52) U.S. Cl. 510/504

(57) ABSTRACT

Methods of treating a fabric wherein a fabric to be treated is provided, a fabric treatment composition comprising a quaternized protein hydrolyzate is provided; and the fabric is contacted with the fabric treatment composition, are described along with methods of reducing the inflammatory and/or skin-irritating effects of a fabric treatment composition by combining a quaternized protein hydrolyzate and a fabric treatment composition.

### BACKGROUND OF THE INVENTION

For more than 50 years now, proteins and their derivatives prepared from a number of natural sources of animal or vegetable origin have been successfully used as care components in cosmetic products.

The problem addressed by the present invention was to find new effects of quaternized protein hydrolyzates for use in detergents. This problem has been solved by the use of quaternized protein hydrolyzates in accordance with the invention as inflammation-inhibiting care components, for conditioning fabrics, for protecting fibers and for smoothing fibers and hence for improving compatibility with the skin.

### SUMMARY OF THE INVENTION

This invention relates generally to detergents and, more particularly, to the use of quaternized protein hydrolyzates as inflammation-inhibiting care components and as fabric conditioners.

The present invention relates to the use of quaternized protein hydrolyzates as inflammation-inhibiting care components in detergents, preferably in laundry detergents, ironing aids, fabric softeners and dryer additives.

The present invention also relates to the use of quaternized protein hydrolyzates as fabric conditioners in detergents, preferably in laundry detergents, ironing aids, fabric softeners and dryer additives, characterized in that the fibers are repaired and smoothed by the quaternized protein hydrolyzates.

In another embodiment, the present invention relates to the use of quaternized protein hydrolyzates as fabric conditioners in detergents, preferably in laundry detergents, ironing aids, fabric softeners and dryer additives, characterized in that the fibers are encapsulated, strengthened and protected by the quaternized protein hydrolyzates.

The present invention also relates to the use of quaternized protein hydrolyzates as fabric conditioners in detergents, preferably in laundry detergents, ironing aids, fabric softeners and dryer additives, characterized in that the electrostatic charging of the fibers is reduced by the absorption of the quaternized protein hydrolyzates onto the fibers.

The present invention also relates to the use of quaternized protein hydrolyzates as fabric conditioners in detergents, preferably in laundry detergents, ironing aids, fabric softeners and dryer additives, characterized in that the resoiling of the fibers is reduced by the absorption of the quaternized protein hydrolyzates onto the fibers.

Where they are used in particular in detergents, fabric softeners, ironing aids and dryer additives, the protein hydrolyzates ensure very high dermatological compatibility of the laundry, even with sensitive skin. This is because the inflammation-inhibiting quaternized protein hydrolyzates, which adhere to the fibers through the washing, fabric softening or drying process or by direct application (for example as an ironing aid), act directly on the skin through the wearing of the textile fibers or textiles.

In addition, the wearing comfort of the laundry is improved by a more pleasant feeling on wearing. This is attributable to the fabric-conditioning effect and more particularly to the smoothing effect on the fibers which can be repaired by the addition of quaternized protein hydrolyzates. The fibers are encapsulated by the quaternized protein hydrolyzates and thus acquire additional physicochemical stability and a smoother surface.

The smoother surface is achieved by film formation or by penetration of the quaternized protein hydrolyzates and the repair of the damaged fibers. The smoother surface reduces the mechanical irritation of the skin by the wearing of the items of laundry thus treated.

In addition, textiles treated with protein-containing agents show a lesser tendency towards resoiling. The electrostatic charging of these textiles is also lower. It has been found that quaternized protein hydrolyzates, more particularly of vegetable origin, especially quaternized wheat protein hydrolyzates, have a pronounced inflammation-inhibiting effect.

Consumers are increasingly complaining about sensitive or even irritated skin. The inflammation-inhibiting effect of the quaternized protein hydrolyzates is therefore an interesting property. Normally, this effect is not only beneficial and soothing to the skin, it is also capable of effectively avoiding irritation of the skin.

In this way, the quaternized protein hydrolyzates are able to soothe the skin and to protect it against irritation and thus to improve the wearing properties of the textiles. Accordingly, the quaternized protein hydrolyzates are suitable for use in laundry detergents. The inflammation-inhibiting quaternized protein hydrolyzates have an anti-inflammatory effect on direct contact with the skin through the washed textiles or fibers. Irritation of the skin is thus minimized. The quaternized protein hydrolyzates may also be introduced into finishing products, such as ironing aids, fabric softeners or dryer additives.

Dryer additives are understood inter alia to be sachets or sheets which contain the protein hydrolyzate formulation and which are placed in the dryer itself during drying of the laundry. The inflammation-inhibiting effect of quaternized protein hydrolyzates is indirectly developed through the smoothing of the fibers of the worn textiles which thus cause less mechanical irritation of the skin.

### DETAILED DESCRIPTION OF THE INVENTION

Quaternized Protein Hydrolyzates

Cationic quaternized protein hydrolyzates are known substances which are eminently suitable for the uses according to the invention. Applicants have found that vegetable products based on degradation products of pea, rice, almond, potato, soya, silk and, in particular, wheat proteins (for example gluten) are particularly suitable for this purpose. The acidic, alkaline and/or enzymatic hydrolysis of these starting materials generally leads to products which have an average molecular weight in the range from 100 to 10,000, preferably in the range from 100 to 5,000 and more particularly in the range from 200 to 1,000 dalton.

For the hydrolysis, an aqueous suspension of the protein-containing starting material is typically degraded—optionally together with the adsorbents, such as active carbon for example—over a period of 1 to 24 h at varying pH values and at the optimum temperature of the proteinases and peptidases used below 70° C. and preferably below 60° C., for example at 30 to 55° C. After the hydrolysis, it is advisable to adjust the pH into the acidic range, for example to pH 3 to 4. If the hydrolysis is carried out in the presence of calcium oxide or calcium hydroxide as base, calcium peptides are formed and have to be filtered off from the residue. If the alkali metal peptides are required, it is advisable to treat the calcium peptides with soda or potash solution and then to remove the poorly soluble calcium carbonate. The calcium may also be precipitated in the form of calcium sulfate or calcium oxalate. The poorly soluble salts are preferably separated off in the presence of filter aids through nutsch filters or filter presses. Aqueous vegetable protein hydrolyzate solutions are obtained and, if desired, may be concentrated, for example, using falling film evaporators. The hydrolyzates obtainable in this way generally have a solids content of about 5 to 50% by weight.

The cationization of the vegetable protein hydrolyzates thus obtained takes place between the free amino and/or carboxyl groups of the oligopeptide and a halogen atom of the quaternary ammonium salt used, hydrogen halide being given off. The quaternary ammonium salts preferably used correspond to formula (I):

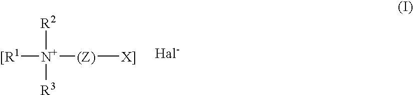

in which R¹ is an alkyl and/or alkenyl group containing 1 to 22 carbon atoms, R² and R³ independently of one another represent an alkyl group containing 1 to 4 carbon atoms, Z is an optionally hydroxysubstituted alkylene group and X and Hal independently of one another represent chlorine or bromine. In one particular embodiment of the invention, the quaternary ammonium salts used are N,N-dimethyl-N-(n-alkyl)-N-(2-hydroxy-3-chloro-n-propyl)-ammonium halides and, in particular, N,N-dimethyl-N-(n-dodecyl)-N-(2-hydroxy-3-chloro-n-propyl)-ammonium chloride.

As already mentioned, the reaction between the protein hydrolyzates and the quaternary ammonium salts is accompanied by the elimination of hydrogen halide and is catalyzed by alkali metal bases. Basically, the choice of the base is not critical although concentrated aqueous solutions of sodium or potassium hydroxide are preferably used. Accordingly, the pH value during the reaction is in the range from 8 to 12 and more particularly around 10.

It has proved to be of advantage to select the molar ratios so that, for every mol of a protein hydrolyzate which contains on average p mol peptide units, there are p/10 to p/100 mol and preferably p/20 to p/50 mol quaternary ammonium salts. In other words, this means that, per mol of protein hydrolyzate containing on average 100 peptide units (p=100), 1 to 10 mol (p/100 to p/10) and preferably 2 to 5 mol (p/50 to p/20) quaternary ammonium salts are used.

The reaction normally takes place at a temperature in the range from 20 to 90° C. and preferably at a temperature in the range from 40 to 60° C. The reaction time is typically 1 to 24 h and, more particularly, 4 to 12 h. It has proved to be of advantage to adjust the end product to a neutral pH by addition of mineral acid and to stabilize it against microbial infestation in the usual way, i.e. for example by addition of PHB esters.

The commercially available products include Gluadin® WQ (Cognis, Düsseldorf). Low molecular weight protein hydrolyzates thus have such a small molecule size that these “microproteins” are even capable of penetrating into the textile fibers and repairing, strengthening and protecting them.

So far as the amino acid composition of the quaternized protein hydrolyzates according to the invention is concerned, the high glutamic acid content is particularly emphasized. Glutamic acid generally occurs widely in nature and can therefore be found in almost all proteins. However, the highest concentration occurs in wheat protein which generally contains more than 30% glutamic acid. Accordingly, it is from gluten, the protein of wheat gluten from which glutamic acid was first obtained, that the name of this protein unit derives. Although glutamic acid is not an essential amino acid, it does play an important role in various metabolism processes.

The quantity in which the quaternized protein hydrolyzates are used, based on the end formulation, may be between 0.1 and 10, preferably between 0.2 and 8 and more particularly between 0.5 and 6% by weight, expressed as active substance.

Commercial Applications

By virtue of their effects, quaternized protein hydrolyzates are suitable for use in detergents. The quaternized protein hydrolyzates according to the invention may be used in solid (granulated or tabletted), liquid and paste-form detergents, fabric softeners, ironing aids and dryer additives. They are particularly suitable for use in liquid laundry detergents. These detergents may additionally contain surfactants, builders, bleaching agents, viscosity adjusters, enzymes (except proteases), enzyme stabilizers, foam inhibitors, pearlizing waxes, soil-repellent polymers (soil repellants), protein hydrolyzates other than those according to the invention, perfume oils and perfumes, solubilizers, inorganic salts and the like.

Surfactants

Suitable surfactants are anionic, nonionic, cationic and/or amphoteric or zwitterionic surfactants which may be present in the preparations in quantities of normally about 1 to 70% by weight, preferably 5 to 50% by weight and more preferably 10 to 30% by weight.

Typical examples of anionic surfactants are soaps, alkyl benzene-sulfonates, alkanesulfonates, olefin sulfonates, alkylether sulfonates, glycerol ether sulfonates, α-methyl ester sulfonates, sulfofatty acids, alkyl sulfates, fatty alcohol ether sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates and alkyl (ether) phosphates. If the anionic surfactants contain polyglycol ether chains, they may have a conventional homolog distribution although they preferably have a narrow-range homolog distribution.

Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and mixed formals, optionally partly oxidized alk(en)yl oligoglycosides or glucuronic acid derivatives, fatty acid-N-alkyl glucamides, polyol fatty acid esters, sugar esters, sorbitan esters, polysorbates, hydroxy mixed ethers and amine oxides. If the nonionic surfactants contain polyglycol ether chains, they may have a conventional homolog distribution, although they preferably have a narrow-range homolog distribution.

Typical examples of cationic surfactants are quaternary ammonium compounds such as, for example, dimethyl distearyl ammonium chloride, and esterquats, more particularly quaternized fatty acid trialkanolamine ester salts.

Typical examples of amphoteric or zwitterionic surfactants are alkylbetaines, alkylamidobetaines, aminopropionates, aminoglycinates, imidazolinium betaines and sulfobetaines. The surfactants mentioned are all known compounds. Typical examples of particularly suitable mild, i.e. particularly dermatologically compatible, surfactants are fatty alcohol polyglycol ether sulfates, monoglyceride sulfates, mono- and/or dialkyl sulfosuccinates, fatty acid isethionates, fatty acid sarcosinates, fatty acid taurides, fatty acid glutamates, α-olefin sulfonates, ether carboxylic acids, alkyl oligoglucosides, fatty acid glucamides, alkylamidobetaines and amphoacetals.

A suitable solid builder is, in particular, finely crystalline zeolite containing synthetic and bound water, such as detergent-quality zeolite NaA. However, zeolite NaX and mixtures of NaA and NaX are also suitable. The zeolite may be used in the form of a spray-dried powder or even as an undried stabilized suspension still moist from its production. Where the zeolite is used in the form of a suspension, the suspension may contain small additions of nonionic surfactants as stabilizers, for example 1 to 3% by weight—based on zeolite—of ethoxylated C₁₂₋₁₈ fatty alcohols containing 2 to 5 ethylene oxide groups or ethoxylated isotridecanols. Suitable zeolites have a mean particle size of less than 10 μm (volume distribution, as measured by the Coulter Counter Method) and contain preferably 18 to 22% by weight and more preferably 20 to 22% by weight of bound water. Suitable substitutes or partial substitutes for zeolites are crystalline layer-form sodium silicates with the general formula NaMSiₓO₂ₓ₊₁. yH₂O, where M is sodium or hydrogen, x is a number of 1.9 to 4 and y is a number of 0 to 20, preferred values for x being 2, 3 or 4. Preferred crystalline layer silicates are those in which M in the general formula stands for sodium and x assumes the value 2 or 3. Both β- and γ-sodium disilicates Na₂Si₂O₅. yH₂O are particularly preferred. The powder-form detergents according to the invention preferably contain 10 to 60% by weight of zeolite and/or crystalline layer silicates as solid builders, mixtures of zeolite and crystalline layer silicates in any ratio being particularly advantageous. In one particularly preferred embodiment, the detergents contain 20 to 50% by weight of zeolite and/or crystalline layer silicates. Particularly preferred detergents contain up to 40% by weight of zeolite and, more particularly, up to 35% by weight of zeolite, based on water-free active substance. Other suitable ingredients of the detergents are water-soluble amorphous silicates which are preferably used in combination with zeolite and/or crystalline layer silicates. Particularly preferred detergents are those which contain above all sodium silicate with a molar ratio of Na₂O to SiO₂ (modulus) of 1:1 to 1:4.5 and preferably 1:2 to 1:3.5. The amorphous sodium silicate content of the detergents is preferably up to 15% by weight and more preferably from 2 to 8% by weight. Phosphates, such as tripolyphosphates, pyrophosphates and orthophosphates, may also be present in the detergents in small quantities. The phosphate content of the detergents is preferably up to 15% by weight and, more particularly, from 0 to 10% by weight. In addition, the detergents may contain layer silicates of natural and synthetic origin. Their suitability for use is not confined to a particular composition or structural formula. However, smectites are preferred, bentonites being particularly preferred. Suitable layer silicates which belong to the group of water-swellable smectites are, for example, those corresponding to the following general formulae:

(OH)₄Si_{8-y}Al_{y}(MgₓAl₄₋ₓ)O₂₀ montmorillonite

(OH)₄Si_{8-y}Al_{y}(Mg_{6-z}Li_{z})O₂₀ hectorite

(OH)₄Si_{8-y}Al_{y}(Mg_{6-z}Al_{z})O₂₀ saponite

where x=0 to 4, y=0 to 2 and z=0 to 6. In addition, small quantities of iron may be incorporated in the crystal lattice of the layer silicates corresponding to the above formulae. By virtue of their ion-exchanging properties, the layer silicates may also contain hydrogen, alkali metal and alkaline earth metal ions, more particularly Na⁺ and Ca²⁺. The quantity of water of hydration is generally in the range from 8 to 20% by weight and is dependent upon the degree of swelling and upon the processing method. Layer silicates which have been substantially freed from calcium ions and strongly coloring iron ions by an alkali treatment are preferably used. Useful organic builders are, for example, the polycarboxylic acids preferably used in the form of their sodium salts, such as citric acid, adipic acidic acid, succinic acid, glutaric acid, tartaric acid, sugar acids, aminocarboxylic acids, nitrilotriacetic acid (NTA), providing their use is not ecologically unsafe, and mixtures thereof. Preferred salts are the salts of polycarboxylic acids, such as citric acid, adipic acid, succinic acid, glutaric acid, tartaric acid, sugar acids and mixtures thereof. Suitable polymeric polycarboxylates are, for example, the sodium salts of polyacrylic acid or polymethacrylic acid, for example those with a relative molecular weight of 800 to 150,000 (based on acid). Suitable copolymeric polycarboxylates are, in particular, those of acrylic acid with methacrylic acid and acrylic acid or methacrylic acid with maleic acid. Copolymers of acrylic acid with maleic acid which contain 50 to 90% by weight of acrylic acid and 50 to 10% by weight of maleic acid are particularly suitable. Their relative molecular weight, based on free acids, is generally in the range from 5,000 to 200,000, preferably in the range from 10,000 to 120,000 and more preferably in the range from 50,000 to 100,000. It is not absolutely essential to use polymeric polycarboxylates. However, if polymeric polycarboxylates are used, detergents containing biodegradable polymers, for example terpolymers which contain acrylic acid and maleic acid or salts thereof and vinyl alcohol or vinyl alcohol derivatives as monomers or acrylic acid and 2-alkyl allyl sulfonic acid or salts thereof and sugar derivatives as monomers are preferred. Terpolymers are particularly preferred. Other suitable builders are polyacetals which may be obtained by reacting dialdehydes with polyol carboxylic acids containing 5 to 7 carbon atoms and at least 3 hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Builders suitable for liquid detergents include ethylenediamine tetraacetic acid, nitrilotriacetic acid, citric acid and inorganic phosphonic acids such as, for example, the neutrally reacting sodium salts of 1-hydroxyethane-1,1-diphosphonate which may be present in quantities of 0.5 to 5 and preferably 1 to 2% by weight.

Among the compounds serving as peroxy bleaching agents, sodium perborate tetrahydrate and sodium perborate monohydrate are particularly important. Other suitable bleaching agents are, for example, peroxycarbonate, citrate perhydrates and H₂O₂-yielding peracidic salts of peracids, such as perbenzoates, peroxyphthalates or diperoxydodecanedioic acid. They are normally used in quantities of 8 to 25% by weight. Sodium perborate monohydrate is preferred and is used in quantities of 10 to 20% by weight and preferably in quantities of 10 to 15% by weight. By virtue of its ability to bind free water to form the tetrahydrate, it contributes towards increasing the stability of the detergent.

Suitable viscosity adjusters are, for example, hydrogenated castor oil, salts of long-chain fatty acids, which are preferably used in quantities of 0 to 5% by weight and more preferably in quantities of 0.5 to 2% by weight, for example sodium, potassium, aluminum, magnesium and titanium stearates or the sodium and/or potassium salts of behenic acid, and other polymeric compounds. Preferred other polymeric compounds include polyvinyl pyrrolidone, urethanes and the salts of polymeric polycarboxylates, for example homopolymeric or copolymeric polyacrylates, polymethacrylates and, in particular, copolymers of acrylic acid with maleic acid, preferably those of 50% to 10% maleic acid. The relative molecular weight of the homopolymers is generally between 1,000 and 100,000 while the relative molecular weight of the copolymers is between 2,000 and 200,000 and preferably between 50,000 and 120,000, based on the free acid. Water-soluble polyacrylates which are crosslinked, for example, with about 1% of a polyallyl ether of sucrose and which have a relative molecular weight above 1,000,000 are also particularly suitable. Examples include the polymers with a thickening effect obtainable under the name of Carbopol® 940 and 941. The crosslinked polyacrylates are preferably used in quantities of not more than 1% by weight and more preferably in quantities of 0.2 to 0.7% by weight. The detergents may additionally contain about 5 to 20% by weight of a partly esterified copolymer. These partly esterified polymers are obtained by copolymerization of (a) at least one C₄₋₂₈ olefin or mixtures of at least one C₄₋₂₈ olefin with up to 20 mol-% of C₁₋₂₈ alkyl vinyl ethers and (b) ethylenically unsaturated dicarboxylic anhydrides containing 4 to 8 carbon atoms in a molar ratio of 1:1 to form copolymers with K values of 6 to 100 and subsequent partial esterification of the copolymers with reaction products, such as C₁₋₁₃ alcohols, C₈₋₂₂ fatty acids, C₁₋₁₂ alkyl phenols, secondary C₂₋₃₀ amines or mixtures thereof, with at least one C₂₋₄ alkylene oxide or tetrahydrofuran and hydrolysis of the anhydride groups of the copolymers to carboxyl groups, the partial esterification of the copolymers being continued to such an extent that 5 to 50% of the carboxyl groups of the copolymers are esterified. Preferred copolymers contain maleic anhydride as the ethylenically unsaturated dicarboxylic anhydride. The partly esterified copolymers may be present either in the form of the free acid or preferably in partly or completely neutralized form. The copolymers are advantageously used in the form of an aqueous solution, more particularly in the form of a 40 to 50% by weight solution. The copolymers not only contribute towards the single wash cycle and multiple wash cycle performance of the liquid detergent, they also promote a desirable reduction in viscosity of the concentrated liquid detergents. By using these partly esterified copolymers, it is possible to obtain concentrated aqueous liquid detergents which flow under the sole effect of gravity, i.e. without any need for other shear forces. In a preferred embodiment, the concentrated aqueous liquid detergents contain partly esterified copolymers in quantities of 5 to 15% by weight and, more particularly, in quantities of 8 to 12% by weight.

Suitable enzymes are those from the class of lipases, amylases, cellulases and mixtures thereof. Enzymes obtained from bacterial strains or fungi, such as Bacillus subtilis, Bacillus licheniformis and Streptomyces griseus, are particularly suitable. Proteases of the subtilisin type are preferably used, proteases obtained from Bacillus lentus being particularly preferred. They may be used in quantities of about 0.2 to about 2% by weight. The enzymes may be adsorbed onto supports and/or encapsulated in membrane materials to protect them against premature decomposition.

In addition to monohydric and polyhydric alcohols and phosphonates, the detergents may contain other enzyme stabilizers. For example, 0.5 to 1% by weight of sodium formate may be used. However, it is of particular advantage to use boron compounds, for example boric acid, boron oxide, borax and other alkali metal borates, such as the salts of orthoboric acid (H₃BO₃), metaboric acid (HBO₂) and pyroboric acid (tetraboric acid H₂B₄O₇).

Where the detergents are used in washing machines, it can be of advantage to add conventional foam inhibitors to them. Suitable foam inhibitors are, for example, soaps of natural or synthetic origin which have a high percentage content of C ₁₈₋₂₄ fatty acids. Suitable non-surface-active foam inhibitors are, for example, organopolysiloxanes and mixtures thereof with microfine, optionally silanized silica and paraffins, waxes, microcrystalline waxes and mixtures thereof with silanized silica or bis-stearyl ethylenediamide. Mixtures of various foam inhibitors, for example mixtures of silicones, paraffins or waxes, may also be used with advantage. The foam inhibitors, more particularly silicone- or paraffin-containing foam inhibitors, are preferably fixed to a granular water-soluble or water-dispersible carrier/support. Mixtures of paraffins and bis-stearyl ethylenediamides are particularly preferred.

The pH value of the particularly preferred concentrated detergents according to the invention is generally in the range from 7 to 10.5, preferably in the range from 7 to 9.5 and more preferably in the range from 7 to 8.5. Higher pH values, for example above 9, can be adjusted by using small quantities of sodium hydroxide or alkaline salts, such as sodium carbonate or sodium silicate. The liquid detergents according to the invention generally have viscosities of 150 to 10,000 mPas (Brookfield viscosimeter, spindle 1, 20 r.p.m., 20° C.). The substantially water-free detergents preferably have viscosities of 150 to 5,000 mPas. The viscosity of aqueous detergents is preferably below 2,000 mPas and, more particularly, in the range from 150 to 1,000 mPas.

Suitable pearlizing waxes are, for example, alkylene glycol esters, especially ethylene glycol distearate; fatty acid alkanolamides, especially cocofatty acid diethanolamide; partial glycerides, especially stearic acid monoglyceride; esters of polybasic, optionally hydroxysubstituted carboxylic acids with fatty alcohols containing 6 to 22 carbon atoms, especially long-chain esters of tartaric acid; fatty compounds, such as for example fatty alcohols, fatty ketones, fatty aldehydes, fatty ethers and fatty carbonates which contain in all at least 24 carbon atoms, especially laurone and distearylether; fatty acids, such as stearic acid, hydroxystearic acid or behenic acid, ring opening products of olefin epoxides containing 12 to 22 carbon atoms with fatty alcohols containing 12 to 22 carbon atoms and/or polyols containing 2 to 15 carbon atoms and 2 to 10 hydroxyl groups and mixtures thereof.

Suitable soil repellants are substances which preferably contain ethylene terephthalate and/or polyethylene glycol terephthalate groups, the molar ratio of ethylene terephthalate to polyethylene glycol terephthalate being in the range from 50:50 to 90:10. The molecular weight of the linking polyethylene glycol units is more particularly in the range from 750 to 5,000, i.e. the degree of ethoxylation of the polymers containing polyethylene glycol groups may be about 15 to 100. The polymers are distinguished by an average molecular weight of about 5,000 to 200,000 and may have a block structure, but preferably have a random structure. Preferred polymers are those with molar ethylene terephthalate:polyethylene glycol terephthalate ratios of about 65:35 to about 90:10 and preferably in the range from about 70:30 to 80:20. Other preferred polymers are those which contain linking polyethylene glycol units with a molecular weight of 750 to 5,000 and preferably in the range from 1,000 to about 3,000 and which have a molecular weight of the polymer of about 10,000 to about 50,000. Examples of commercially available polymers are the products Milease® T (ICI) or Repelotex® SRP 3 (Rhône-Poulenc).

Suitable cationic polymers are, for example, cationic cellulose derivatives such as, for example, the low molecular weight hydroxyethyl cellulose obtainable from Amerchol under the name of Polymer JR400®, cationic starch, copolymers of diallyl ammonium salts and acrylamides, low molecular weight vinyl pyrrolidone/vinyl imidazole polymers such as, for example, Luviquat® (BASF), polyethyleneimine, cationic silicone polymers such as, for example, amodimethicone, copolymers of adipic acid and dimethylaminohydroxypropyl diethylene-triamine (Cartaretine®, Sandoz), copolymers of acrylic acid with dimethyl diallyl ammonium chloride (Merquat® 550, Chemviron), polyaminopolyamides and crosslinked water-soluble polymers thereof, cationic chitin derivatives such as, for example, low molecular weight chitosan, optionally in microcrystalline distribution, condensation products of dihaloalkyls, for example dibromobutane, with bis-dialkylamines, for example bis-dimethylamino-1,3-propane, cationic guar gum such as, for example, Jaguar®CBS, Jaguar®C-17, Jaguar®C-16 of Celanese, low molecular weight ammonium salt polymers such as, for example, Mirapol® A-15, Mirapol® AD-1, Mirapol® AZ-1 of Miranol.

Suitable anionic, zwitterionic, amphoteric and nonionic polymers are, for example, vinyl acetate/crotonic acid copolymers, vinyl pyrrolidone/vinyl acrylate copolymers, vinyl acetate/butyl maleate/isobomyl acrylate copolymers, methyl vinylether/maleic anhydride copolymers and esters thereof, uncrosslinked and polyol-crosslinked polyacrylic acids, acrylamidopropyl trimethylammonium chloride/acrylate copolymers, octylacrylamide/methyl methacrylate/tert.-butylaminoethyl methacrylate/2-hydroxypropyl methacrylate copolymers, polyvinyl pyrrolidone, vinyl pyrrolidone/vinyl acetate copolymers, vinyl pyrrolidone/dimethylaminoethyl methacrylate/vinyl caprolactam terpolymers and optionally derivatized cellulose ethers and silicones.

Suitable perfume oils and perfumes are mixtures of natural and synthetic perfumes. Natural perfumes include the extracts of blossoms (lily, lavender, rose, jasmine, neroli, ylang-ylang), stems and leaves (geranium, patchouli, petitgrain), fruits (anise, coriander, caraway, juniper), fruit peel (bergamot, lemon, orange), roots (nutmeg, angelica, celery, cardamon, costus, iris, calmus), woods (pinewood, sandalwood, guaiac wood, cedarwood, rosewood), herbs and grasses (tarragon, lemon grass, sage, thyme), needles and branches (spruce, fir, pine, dwarf pine), resins and balsams (galbanum, elemi, benzoin, myrrh, olibanum, opoponax). Animal raw materials, for example civet and beaver, may also be used. Typical synthetic perfume compounds are products of the ester, ether, aldehyde, ketone, alcohol and hydrocarbon type. Examples of perfume compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal. Examples of suitable ketones are the ionones, α-isomethylionone and methyl cedryl ketone. Suitable alcohols are anethol, citronellol, eugenol, isoeugenol, geraniol, linalool, phenylethyl alcohol and terpineol. The hydrocarbons mainly include the terpenes and balsams. However, it is preferred to use mixtures of different perfume compounds which, together, produce an agreeable fragrance. Other suitable perfume oils are essential oils of relatively low volatility which are mostly used as aroma components. Examples are sage oil, chamomile oil, clove oil, melissa oil, mint oil, cinnamon leaf oil, lime-blossom oil, juniper berry oil, vetiver oil, olibanum oil, galbanum oil, ladanum oil and lavendin oil. The following are preferably used either individually or in the form of mixtures: bergamot oil, dihydromyrcenol, lilial, lyral, citronellol, phenylethyl alcohol, α-hexylcinnamaldehyde, geraniol, benzyl acetone, cyclamen aldehyde, linalool, Boisambrene Forte, Ambroxan, indole, hedione, sandelice, citrus oil, mandarin oil, orange oil, allylarnyl glycolate, cyclovertal, lavendin oil, clary oil, β-damascone, geranium oil bourbon, cyclohexyl salicylate, Vertofix Coeur, Iso-E-Super, Fixolide NP, evemyl, iraldein gamma, phenylacetic acid, geranyl acetate, benzyl acetate, rose oxide, romillat, irotyl and floramat.

Suitable aromas are, for example, peppermint oil, spearmint oil, aniseed oil, Japanese anise oil, caraway oil, eucalyptus oil, fennel oil, citrus oil, wintergreen oil, clove oil, menthol and the like.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of treating a fabric, said method comprising:
(a) providing a fabric to be treated;
(b) providing a fabric treatment composition comprising a quaternized protein hydrolyzate; and
(c) contacting the fabric with the fabric treatment composition.

2. The method according to claim 1, wherein the fabric treatment composition is selected from the group consisting of laundry detergents, ironing aids, fabric softeners and dryer additives.

3. The method according to claim 1, wherein the quaternized protein hydrolyzate comprises a quaternized vegetable protein hydrolyzate.

4. The method according to claim 1, wherein the quaternized protein hydrolyzate comprises a quaternized wheat protein hydrolyzate.

5. The method according to claim 1, wherein the quaternized protein hydrolyzate has an average molecular weight of from 100 to 10000 daltons.

6. The method according to claim 1, wherein the quaternized protein hydrolyzate has an average molecular weight of from 100 to 5000 daltons.

7. The method according to claim 1, wherein the quaternized protein hydrolyzate has an average molecular weight of from 200 to 1000 daltons.

8. The method according to claim 1, wherein the quaternized protein hydrolyzate is present in the fabric treatment composition in an amount of from 0.1 to 10% by weight, based on the fabric treatment composition and expressed as active substance.

9. A method of reducing the inflammatory and/or skin-irritating effects of a fabric treatment composition, said method comprising:
(a) providing a quaternized protein hydrolyzate;
(b) providing a fabric to be treated with a fabric treatment composition;
(c) combining the quaternized protein hydrolyzate and the fabric treatment composition; and
(d) treating the fabric with the combined quaternized protein hydrolyzate and fabric treatment composition.

10. The method according to claim 9, wherein the fabric treatment composition is selected from the group consisting of laundry detergents, ironing aids, fabric softeners and dryer additives.

11. The method according to claim 9, wherein the quaternized protein hydrolyzate comprises a quaternized vegetable protein hydrolyzate.

12. The method according to claim 9, wherein the quaternized protein hydrolyzate comprises a quaternized wheat protein hydrolyzate.

13. The method according to claim 19, wherein the quaternized protein hydrolyzate has an average molecular weight of from 100 to 10000 daltons.

14. The method according to claim 9, wherein the quaternized protein hydrolyzate has an average molecular weight of from 100 to 5000 daltons.

15. The method according to claim 9, wherein the quaternized protein hydrolyzate has an average molecular weight of from 200 to 1000 daltons.

16. The method according to claim 9, wherein the quaternized protein hydrolyzate is combined with the fabric treatment composition in an amount of from 0.1 to 10% by weight, based on the fabric treatment composition and expressed as active substance.
